(19) United States
(12) Patent Application Publication
(10) Pub. No.: US 2014/0126507 A1
(43) Pub. Date: May 8, 2014

(54) RECEIVING APPARATUS, FREQUENCY ASSIGNMENT METHOD, CONTROL PROGRAM, AND INTEGRATED CIRCUIT

(71) Applicants: Hiroki Takahashi, Osaka-shi (JP); Yasuhiro Hamaguchi, Osaka-shi (JP); Kazunari Yokomakura, Osaka-shi (JP); Osamu Nakamura, Osaka-shi (JP); Jungo Goto, Osaka-shi (JP)

(72) Inventors: Hiroki Takahashi, Osaka-shi (JP); Yasuhiro Hamaguchi, Osaka-shi (JP); Kazunari Yokomakura, Osaka-shi (JP); Osamu Nakamura, Osaka-shi (JP); Jungo Goto, Osaka-shi (JP)

(73) Assignee: SHARP KABUSHIKI KAISHA, Osaka-shi, Osaka (JP)

(21) Appl. No.: 14/126,082

(22) PCT Filed: Jun. 13, 2012
(86) PCT No.: PCT/JP2012/065125

§ 371 Date: Dec. 13, 2013

(30) Foreign Application Priority Data
Jun. 15, 2011 (JP) 2011-132949

(51) Int. Cl. H04L 1/08; H04L 5/00

(52) U.S. Cl. CPC H04L 1/08; H04L 5/0055
USPC 370/329

(57) ABSTRACT

In a communication system using retransmission control, throughput reduction is suppressed in a state in which an occurrence rate of retransmission is high. A receiving apparatus configured to, in a case where a signal received from a transmitting apparatus includes an error, request the transmitting apparatus to provide a retransmission signal, includes check units 217-1 to 217-U that make a determination as to whether the signal received from the transmitting apparatus includes an error, and a scheduling unit 211 that performs a frequency assignment such that in a case where a result of the determination indicates that the received signal includes an error, at least a part of a frequency band used by the transmitting apparatus to transmit the retransmission signal overlaps at least a part of a frequency band used by the transmitting apparatus or another different transmitting apparatus to transmit a signal other than the retransmission signal.

### TECHNICAL FIELD

The present invention relates to a transmission method in a wireless communication system that performs retransmission control.

### BACKGROUND ART

In wireless communication, in a case where a received signal is subjected to signal distortion in a transmission channel or is influenced by thermal noise in a receiving apparatus, a bit error occurs, which causes degradation in communication quality. Such degradation in communication quality is generally compensated for by a channel equalization process or based on an error correction code. However, it is not always possible to correctly decode data. Thus, in a case where a receiving apparatus fails to correctly decode data, a retransmission control (also called ARQ (Automatic Repeat reQuest)) is performed to retransmit the same data. In particular, in recent years, hybrid ARQ (H-ARQ) has been used. In this technique, information associated with a received signal in a first-time transmission (initial transmission) or in a retransmission in which a detection error occurs is stored until a next retransmission is performed, and the stored signal is combined with a retransmission signal thereby increasing a retransmission efficiency. Two mainly used examples of H-ARQ are a Chase combining (CC) method (NPL 1) and an incremental redundancy (IR) method (NPL 2).

In the CC method, when a retransmission is performed, the same transmission signal as that transmitted in an initial transmission is transmitted. In a receiving apparatus, the received signal in the initial transmission and the received signal in the retransmission are combined. The combining performed in the above-described manner results in an increase in the reception level of the received signal, and also leads to an achievement of time diversity. Therefore, the error rate characteristic is improved each time the retransmission is repeated.

On the other hand, in retransmission using the IR method, a retransmission signal is configured so as to include a (punctured) code bit that is not transmitted in the initial transmission. In the receiving apparatus, likelihoods of code bits decoded from the initial transmission signal are combined with likelihoods of code bits decoded from the retransmission signal. This results in a reduction in a coding rate in error correction decoding when the retransmission is performed, and thus the error correction capability is enhanced. In the IR method, as described above, the coding rate in the error correction coding can be reduced each time the retransmission is performed, and thus it is possible to reduce the number of times the retransmission is performed compared with usual ARQ, which results in an improvement in throughput.

Next, methods of transmitting a retransmission signal are described. One of retransmission methods is a synchronous retransmission in which a retransmission signal is transmitted, after an elapse of a predetermined time, using the same radio resource as that used in initial transmission. Another transmission method is an asynchronous retransmission in which a retransmission signal is transmitted together with information indicating a packet (block, frame) for which the retransmission signal is transmitted thereby making it possible to use an arbitrary radio resource. In the case of the synchronous method, it is necessary to ensure that a specific resource is allocated, and thus it is a top priority to allocate such a specific resource when radio resources are assigned. In the case of the asynchronous retransmission, it is necessary to assign a radio resource in a similar manner to that for other users in initial transmissions. In particular in the case of the CC method, the same transmission signal is retransmitted, and thus it is necessary to ensure that a band width necessary for the transmission of the same transmission signal is allocated.

### CITATION LIST

### Non Patent Literature

NPL 1: D. Chase, “Code combining—A maximum likelihood decoding approach for combing and arbitrary number of noisy packets”
NPL 2: J. Hagenauer, “Rate-compatible punctured convolutional codes (RCPC codes) and their application,” IEEE Trans. Commun., vol. 36, pp. 389-400, April 1988

### SUMMARY OF INVENTION

### Technical Problem

However, a problem with the retransmission control described above is that it is necessary, in any method, to ensure that a radio resource is allocated when a retransmission is performed, which results in a reduction in a relative amount of radio resource allowed to be assigned to a terminal (initial-transmission terminal) that transmits an initial transmission signal in the same transmission opportunity, and thus the throughput decreases with an occurrence rate of transmission.

In view of the above-described situation, it is an object of the present invention to provide, in a communication system using retransmission control, a receiving apparatus, a frequency assignment method, a control program, and an integrated circuit, capable of suppressing a reduction in throughput in a state in which an occurrence rate of retransmission is high.

### Solution to Problem

(1) To achieve the object described above, the present invention provides a solution as described below. That is, the present invention provides a receiving apparatus that includes at least one receive antenna and, in a case where a signal received from a transmitting apparatus includes an error, requests the transmitting apparatus to provide a retransmission signal, including a check unit that makes a determination as to whether the signal received from the transmitting apparatus includes an error, and a scheduling unit that, in a case where a result of the determination indicates that the received signal includes an error, performs a frequency assignment such that a frequency band for use by the transmission apparatus to transmit the retransmission signal are overlapped by a greater number of different signals than the number of receive antennas.

By performing the frequency assignment such that a greater number of different signals overlap in the frequency band for use by the transmitting apparatus to transmit the retransmission signal as in the above-described manner, it becomes possible to prevent a reduction in overall throughput of a cell as a whole due to a retransmission.

(2) Furthermore, in the receiving apparatus according to the present invention, the scheduling unit performs the frequency assignment such that at least a part of the frequency band used by the transmitting apparatus to transmit the retransmission signal overlaps at least a part of a frequency band used by the transmitting apparatus or another different transmitting apparatus to transmit a signal other than the retransmission signal.

As described above, the receiving apparatus performs the frequency assignment such that in the case where the received signal includes an error, at least a part of the frequency band used by the transmitting apparatus to transmit the retransmission signal overlaps at least a part of the frequency band used by the transmitting apparatus or another different transmitting apparatus to transmit a signal other than the retransmission signal, and thus it becomes possible to prevent a reduction in overall throughput of a cell as a whole due to a retransmission.

(3) Furthermore, in the receiving apparatus according to the present invention, the scheduling unit performs the frequency assignment such that at least a part of the frequency band used by the transmitting apparatus to transmit the retransmission signal overlaps at least a part of a frequency band used by the other transmitting apparatus to transmit an initial transmission signal.

As described above, the receiving apparatus performs the frequency assignment such that at least a part of the frequency band used by the transmitting apparatus to transmit the retransmission signal overlaps at least a part of the frequency band used by the other transmitting apparatus to transmit the initial transmission signal, and thus it is possible to prevent a frequency resource from being occupied by a retransmission terminal, which allows it to increase an amount of frequency resource assigned to an initial-transmission terminal.

(4) Furthermore, in the receiving apparatus according to the present invention, in a case where the received signal includes an error, the scheduling unit performs a determination based on decoding information as to whether or not to perform the frequency assignment such that at least a part of the frequency band used by the transmitting apparatus to transmit the retransmission signal overlaps at least a part of a frequency band used by the other transmitting apparatus to transmit an initial transmission signal.

As described above, in the case where the received signal includes an error, the receiving apparatus performs a determination based on decoding information as to whether or not to perform the frequency assignment such that at least a part of the frequency band used by the transmitting apparatus to transmit the retransmission signal overlaps at least a part of a frequency band used by the other transmitting apparatus to transmit an initial transmission signal, and thus it becomes possible to limit IUI that occurs, which makes it easy to separate signals among mobile stations by the turbo equalization process.

(5) Furthermore, in the receiving apparatus according to the present invention, the decoding information is a mean absolute value of log likelihood ratios of coded bits obtained after a decoding process is performed, and the scheduling unit performs the frequency assignment such that in a case where the decoding information is equal to or greater than a predetermined reference value, at least a part of the frequency band used by the transmitting apparatus to transmit the retransmission signal overlaps at least a part of a frequency band used by the other transmitting apparatus to transmit an initial transmission signal, while in a case where the decoding information is smaller than the predetermined reference value, the frequency band used by the transmitting apparatus to transmit the retransmission signal does not overlap the frequency band used by the other transmitting apparatus to transmit the initial transmission signal.

As described above, the receiving apparatus performs the frequency assignment such that in the case where the decoding information is equal to or greater than the predetermined reference value, at least a part of the frequency band used by the transmitting apparatus to transmit the retransmission signal overlaps at least a part of a frequency band used by the other transmitting apparatus to transmit an initial transmission signal, while in the case where the decoding information is smaller than the predetermined reference value, the frequency band used by the transmitting apparatus to transmit the retransmission signal does not overlap the frequency band used by the other transmitting apparatus to transmit the initial transmission signal, and thus it becomes possible to limit IUI that occurs, which makes it easy to separate signals among mobile stations by the turbo equalization process.

(6) Furthermore, in the receiving apparatus according to the present invention, the scheduling unit determines an overlapping ratio between the frequency band used by the transmitting apparatus to transmit the retransmission signal and the frequency band used by the other transmitting apparatus to transmit the initial transmission signal.

As described above, the receiving apparatus determines the overlapping ratio between the frequency band used by the transmitting apparatus to transmit the retransmission signal and the frequency band used by the other transmitting apparatus to transmit the initial transmission signal, and thus it becomes possible to limit IUI that occurs, which makes it easy to separate signals among mobile stations by the turbo equalization process.

(7) Furthermore, the receiving apparatus according to the present invention further includes a code combining unit that combines the initial transmission signal and the retransmission signal by using Chase combining (CC).

As described above, the receiving apparatus combines the initial transmission signal and the retransmission signal by using Chase combining (CC), and thus it is possible to improve a reception level of a received signal and also achieve time diversity. Thus, the error rate characteristic is improved each time the retransmission is repeated.

(8) Furthermore, the receiving apparatus according to the present invention further includes a code combining unit that combines the initial transmission signal and the retransmission signal by using incremental redundancy (IR).

As described above, the receiving apparatus combines the initial transmission signal and the retransmission signal by using incremental redundancy (IR), and thus it is possible to reduce the coding rate of the error correction decoding each time retransmission is performed, which allows a reduction in the number of times the retransmission is performed compared with usual ARQ and thus allows an improvement in throughput.

(9) Furthermore, the receiving apparatus according to the present invention includes a buffer unit that stores decoding information in a case where the received signal includes an error, a soft replica generation unit that, in a case where the retransmission signal is received from the transmitting apparatus, generates a replica of the retransmission signal based on the decoding information stored in the buffer unit, an interference replica generation unit that generates an interference replica by using the replica of the retransmission signal and information indicating an interference received by another transmitting apparatus, and a soft cancellation unit that cancels an inter-user interference from the received retransmission signal by using the interference replica.

As described above, in a case where the retransmission signal is received from the transmitting apparatus, the receiving apparatus generates the replica of the retransmission signal based on the stored decoding information, generates the interference replica by using the replica of the retransmission signal and information indicating the interference received by the other transmitting apparatus, and cancels the inter-user interference from the received retransmission signal by using the interference replica, and thus it becomes possible to prevent a reduction in overall throughput of a cell as a whole due to a retransmission.

(10) Furthermore, the present invention provides a method of assigning a frequency to a receiving apparatus that requests a transmitting apparatus to provide a retransmission signal in a case where a signal received from the transmitting apparatus includes an error, including in the case where the received signal includes an error, performing a frequency assignment such that a frequency band for use by the transmitting apparatus to transmit the retransmission signal is overlapped by a greater number of different signals than the number of receive antennas.

As described above, in the case where the received signal includes an error, the receiving apparatus performs the frequency assignment such that the frequency band for use by the transmitting apparatus to transmit the retransmission signal is overlapped by a greater number of different signals than the number of receive antennas, and thus it becomes possible to prevent a reduction in overall throughput of a cell as a whole due to a retransmission.

(11) Furthermore, the present invention provides a control program of a receiving apparatus that requests a transmitting apparatus to provide a retransmission signal in a case where a signal received from the transmitting apparatus includes an error, the control program configured to control a computer to execute a sequence of processes including a process of determining whether the signal received from the transmitting apparatus includes an error or not, and a process of, in a case where a result of the determination indicates that the received signal includes an error, performing a frequency assignment such that a frequency band for use by the transmitting apparatus to transmit the retransmission signal is overlapped by a greater number of different signals than the number of receive antennas.

As described above, in the case where the received signal includes an error, the receiving apparatus performs the frequency assignment such that the frequency band for use by the transmitting apparatus to transmit the retransmission signal is overlapped by a greater number of different signals than the number of receive antennas, and thus it becomes possible to prevent a reduction in overall throughput of a cell as a whole due to a retransmission.

(12) Furthermore, the present invention provides an integrated circuit that is disposed in a receiving apparatus to allow the receiving apparatus to have a plurality of functions including a function of, in a case where a signal received from a transmitting apparatus includes an error, requesting the transmitting apparatus to provide a retransmission signal, a function of determining whether the signal received from the transmitting apparatus includes an error or not, and a function of, in a case where a result of the determination indicates that the received signal includes an error, performing a frequency assignment such that a frequency band for use by the transmitting apparatus to transmit the retransmission signal is overlapped by a greater number of different signals than the number of receive antennas.

As described above, in the case where the received signal includes an error, the receiving apparatus performs the frequency assignment such that the frequency band for use by the transmitting apparatus to transmit the retransmission signal is overlapped by a greater number of different signals than the number of receive antennas, and thus it becomes possible to prevent a reduction in overall throughput of a cell as a whole due to a retransmission.

### Advantageous Effects of Invention

By applying the present invention, it is possible to prevent a frequency resource from being occupied by a retransmission terminal, which allows it to increase an amount of frequency resource assigned to an initial-transmission terminal, and thus it is possible to improve the frequency efficiency and throughput.

### BRIEF DESCRIPTION OF DRAWINGS

FIG. 1 is a diagram illustrating an example of a concept of a retransmission method in a wireless communication system according to a first embodiment of the present invention.

FIG. 2 is a block diagram illustrating a basic configuration of a mobile station apparatus according to the first embodiment of the present invention.

FIG. 3 is a block diagram illustrating a configuration of a base station apparatus according to the first embodiment of the present invention.

FIG. 4 is a block diagram illustrating an internal configuration of a data signal detection unit 213-u according to the first embodiment of the present invention.

FIG. 5 is a flow chart illustrating an operation of a base station apparatus according to the first embodiment of the present invention.

FIG. 6 is a block diagram illustrating an example of a basic configuration of a mobile station apparatus according to a second embodiment of the present invention.

FIG. 7 is a block diagram illustrating an example of an internal configuration of data signal detection units 401-1 to 401-U according to the second embodiment of the present invention.

FIG. 8 is a diagram illustrating a method of assigning bands to mobile station apparatuses by a scheduling unit 211 according to the second embodiment of the present invention.

FIG. 9 is a block diagram illustrating an example of a basic configuration of a mobile station apparatus according to a third embodiment of the present invention.

FIG. 10 is a diagram illustrating an example of a manner in which coded bits are generated by a coding unit 605 and a puncturing unit 607.

FIG. 11 is a block diagram illustrating a configuration of a base station apparatus according to the third embodiment of the present invention.

FIG. 12 is a diagram illustrating an example of a combining method for a case where an initial transmission signal and a retransmission signal illustrated in FIG. 10 are transmitted by a mobile station apparatus according to the third embodiment of the present invention.

FIG. 13 is a flow chart illustrating an operation of the base station apparatus according to the third embodiment of the present invention.

FIG. 14 is a diagram illustrating an example of a concept of a retransmission method in a conventional wireless communication system.

### DESCRIPTION OF EMBODIMENTS

Embodiments of the present invention are described below with reference to drawings. In the following description of the embodiments, an explanation is given as to an up-link transmission in which a transmitting apparatus is a mobile station and a receiving apparatus is a base station. Note that the embodiments are also applicable to a down-link transmission (from a base station to a mobile station).

### First Embodiment

In a first embodiment disclosed below, in a wireless communication system using a retransmission method in which when data is retransmitted, the same data as that transmitted in a first-time transmission (initial transmission) is transmitted, it is allowed to assign the same frequency in an overlapping manner to both a mobile station that transmits an initial transmission signal and a mobile station that transmits a retransmission signal in the same transmission opportunity. However, at a frequency assigned to a plurality of mobile stations, inter-user interference (IUI) occurs among transmission signals. Thus, in the present embodiment, a base station apparatus cancels IUI using an iterative equalization technique which is nonlinear processing based on a replica generated according to a likelihood of a decoded bit in an initial transmission thereby separating signals of the respective mobile stations. To illustrate the method of assigning bands to mobile station apparatuses according to the present embodiment, features thereof are described below in comparison with a conventional band assignment method.

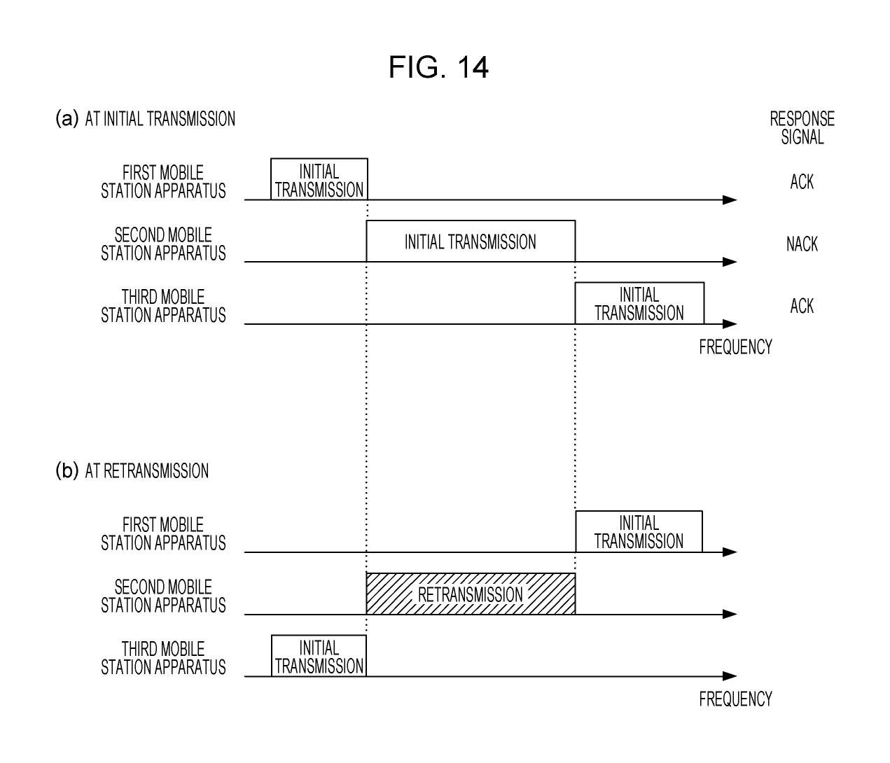

FIG. 14 is a diagram illustrating an example of a concept of a retransmission method in a conventional wireless communication system. In this example, it is assumed that the synchronous retransmission method is used, and retransmission is performed after an elapse of a fixed time predefined in a system using the same radio resource as that used in the initial transmission. Note that a similar assignment method may be applied to an asynchronous retransmission. In this case, a band assignment for a retransmission is performed such that the same amount of resource as that in an initial transmission is assigned at an arbitrary frequency and such that the same transmission rate is achieved as that in the initial transmission.

First, a first mobile station apparatus, a second mobile station apparatus, and a third mobile station apparatus map signals on a frequency axis in order a first transmission signal, a second transmission signal, and a third transmission signal. Note that the transmission signals of the respective mobile station apparatuses are assigned different frequencies such that the transmission signals are orthogonal to each other in a frequency domain. Let it be assumed herein that when these transmission signals are received by the base station apparatus, the transmission signals from the first mobile station apparatus and the third mobile station apparatus are received with no error, but an error (signal detection error) occurs in a decoded bit for the transmission signal from the second mobile station apparatus. In this case, the base station apparatus transmits, as response signals, an acknowledgement (ACK) signal to the first mobile station apparatus and the third mobile station apparatus, and a negative acknowledgement (NACK) signal to the second mobile station apparatus. In the case of the synchronous retransmission, in response to receiving the NACK signal, the second mobile station apparatus transmits a retransmission signal using the same frequency resource as that used in the initial transmission after an elapse of a predetermined time since the initial transmission. Thus, when the second mobile station apparatus performs the retransmission, a scheduling unit of the base station apparatus first assigns the same band to the second mobile station apparatus as that used in the initial transmission, and then, to the first mobile station apparatus and the third mobile station apparatus which are to transmit new data, the scheduling unit of the base station apparatus assigns frequencies that are not used by the second mobile station apparatus. Therefore, the overall throughput of a cell as a whole decreases with increasing ratio of the frequency resource used by a mobile station apparatus such as the second mobile station apparatus that performs a retransmission to a total system band.

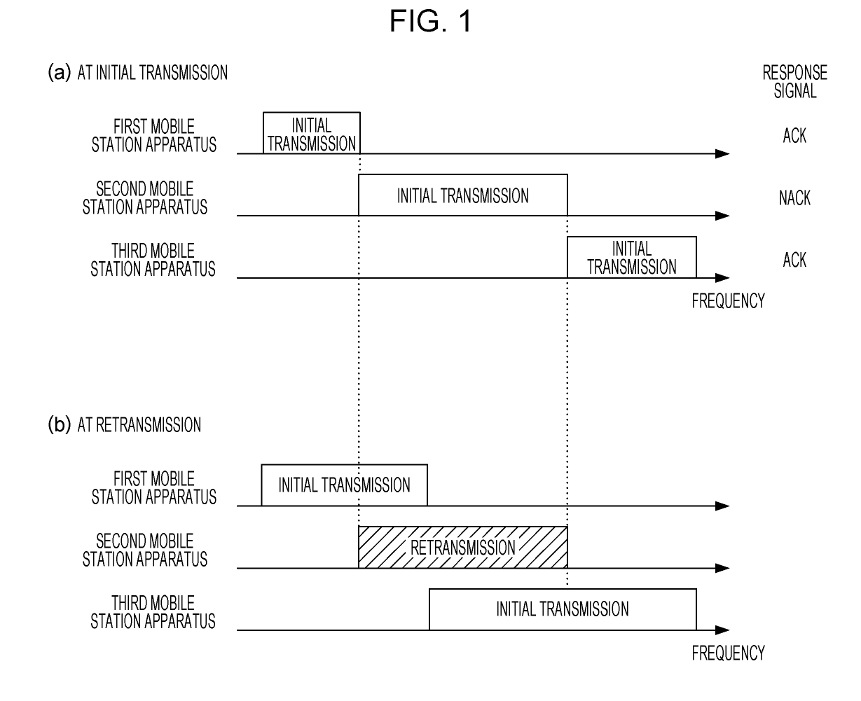

FIG. 1 is a diagram illustrating an example of a concept of a retransmission method in a wireless communication system according to the first embodiment of the present invention. In the present embodiment, as illustrated in FIG. 1, a frequency assigned to a retransmission signal is an assignable frequency that is allowed to be used by another mobile station apparatus to perform a transmission. In the example illustrated in FIG. 1, the transmission signal of the first mobile station apparatus and the transmission signal of the third mobile station apparatus use frequencies that are partially equal to a frequency of the retransmission signal of the second mobile station apparatus. By assigning frequencies in such a manner, it becomes possible to use the assignable band in the cell without being limited by retransmission signals, which prevents a reduction in the overall transmission rate of the cell as a whole from occurring.

In the case where the assignment is made in the above-described manner, signals are received by the base station apparatus such that at least partial overlapping occurs between an initial transmission signal and a retransmission signal. In this situation, in a case where the number of overlapping signals is greater than the number of receive antennas (for example, in a case where there are two or more overlapping signals when the base station apparatus has one receive antenna, or in a case where there are three or more overlapping signals when the base station apparatus has two receive antennas), IUI occurs in a cell. In this situation, of course, depending on a ratio of a reception signal to interference including IUI and noise power (SINR), it may be possible to separate signals. However, in general, the error rate is worse than is obtained in conventional techniques. In the present embodiment, in view of the above, the base station apparatus includes a feedback loop that feeds reliability associated with transmission bits obtained after the error correction decoding is performed or decoded bits back to an equalization unit that performs an equalization process. The feedback loop may be of a decision feedback type in which a hard decision value is fed back, or may be of a turbo equalization type in which reliability of a transmission such as a log likelihood ratio (LLR) is fed back. In the following description, it is assumed by way of example but not limitation that the separation method using the turbo equalization is employed.

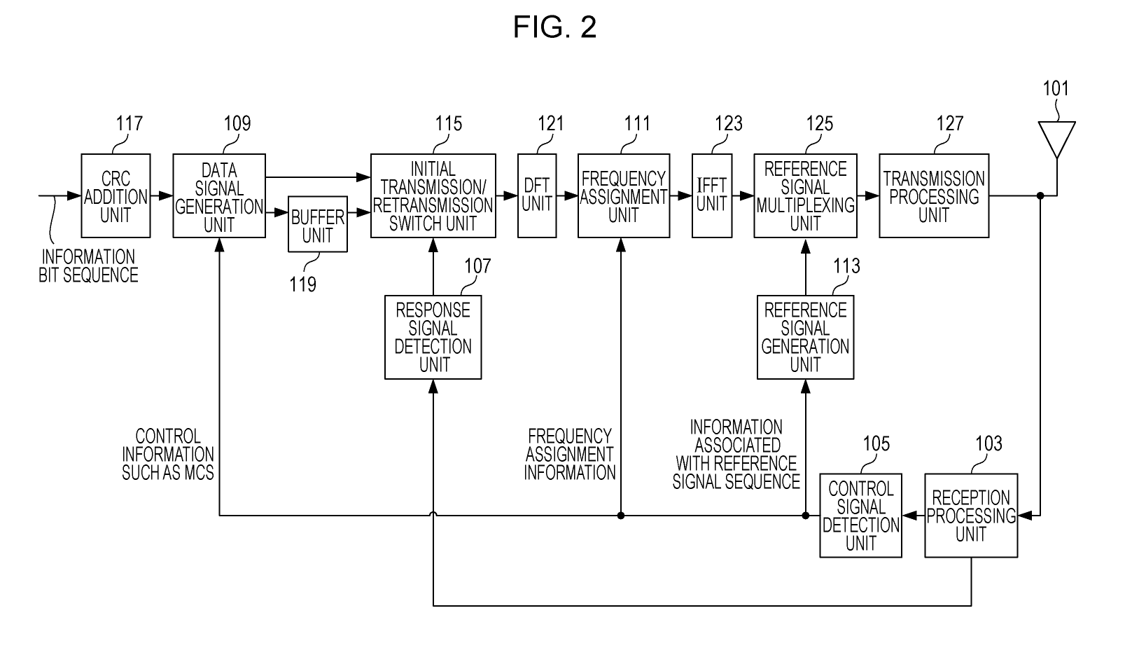

FIG. 2 is a block diagram illustrating a basic configuration of a mobile station apparatus according to the first embodiment of the present invention. First, the mobile station apparatus receives, via an antenna 101, a control signal transmitted via a down-link from a base station apparatus. In a reception processing unit 103, the received control information is down converted to a baseband signal and is converted to a digital signal by an analog-to-digital (A/D) conversion. The resultant digital signal is input to a control signal detection unit 105 and a response signal detection unit 107. From the input baseband signal, the control signal detection unit 105 detects information associated with a modulation scheme and a coding rate (which are also referred to, as a whole, as a modulation and coding scheme (MCS)) necessary in generating a data signal, frequency assignment information, information associated with a reference signal sequence, and the like. These pieces of information are respectively input to a data signal generation unit 109, a frequency assignment unit 111, and a reference signal generation unit 113. On the other hand, in the response signal detection unit 107, an acknowledgement (ACK) signal is received in a case where a signal transmitted in a previous transmission opportunity is correctly received by a base station apparatus described below, while a negative ACK (NACK) signal is received in a case where the signal is not correctly received by the base station apparatus, and either one of these response signals is detected and is input to an initial transmission/retransmission switch unit 115.

On the other hand, an information bit sequence to be transmitted from the mobile station apparatus to the base station apparatus is first input to a CRC addition unit 117, and a cyclic redundancy check (CRC) code is added thereto for use by the base station apparatus to check whether decoding is correctly performed. In the data signal generation unit 109, from the input from the CRC addition unit 117, a time-domain signal of transmission data is generated based on the control information obtained via the control signal detection unit 105. First, an error correction coding process is performed to generate a convolutional code, a turbo code, or a low density parity check (LDPC) code serving as an error correction code such that the notified coding rate is achieved. Next, coded bits are subjected to a modulation process using a modulation scheme notified as the control information, such as quaternary phase shift keying (QPSK), 16 quadrature amplitude modulation (16 QAM), or 64 QAM. A generated modulation symbol is input to an initial transmission/retransmission switch unit 115 and a buffer unit 119.

The buffer unit 119 has a function of storing the modulation symbol input from the data signal generation unit 109. When a response signal for this modulation symbol is received, the modulation symbol stored in the buffer unit 119 is input to the initial transmission/retransmission switch unit 115. In accordance with the response signal input from the response signal detection unit 107, the initial transmission/retransmission switch unit 115 switches the modulation symbol to be input to a DFT unit 121. In a case where the response signal is ACK, an initial-transmission modulation symbol input from the data signal generation unit 109 is output to the DFT unit 121, while in a case where the is response signal NACK, the modulation symbol stored in the buffer unit 119 is output to the DFT unit 121. Note that in the case where the response signal is NACK, the initial-transmission modulation symbol input from the data signal generation unit 109 is used again at a next transmission opportunity. Although in the present example, the buffer unit 119 and the initial transmission/retransmission switch unit 115 perform the storing and switching, respectively, in the time domain after the modulation, the buffer unit 119 and the initial transmission/retransmission switch unit 115 may be disposed at locations following the DFT unit 121 and the processes may be performed in the frequency domain. Furthermore, in the case of the synchronous retransmission method is employed in which the same frequency resource is used for both the initial transmission and the retransmission, the buffer unit 119 and the initial transmission/retransmission switch unit 115 may be disposed at locations following the frequency assignment unit 111.

The modulation symbols are input in units of N_{DFT} symbols from the initial transmission/retransmission switch unit 115 to the DFT unit 121 and converted into frequency-domain signals by an N_{DFT}-point discrete Fourier transform (DFT). In the frequency assignment unit 111, the frequency-domain signals are mapped to N_{DFT} points of specified frequencies of N_{FFT} points of frequencies within a system band based on the frequency assignment information input from the control signal detection unit 105. Examples of assignment methods include discrete Fourier transform spread orthogonal frequency division multiplexing (DFT-S-OFDM, also called SC-FDMA) in which frequency-domain signals are assigned within a contiguous frequency band, clustered DFT-S-OFDM in which frequency-domain signals are assigned over separate frequency bands, and the like, and an arbitrary method determined between transmitting and receiving ends may be used. An IFFT unit 123 converts the N_{FFT} points of frequency signals with the assigned frequencies into a time-domain signal by an N_{FFT}-point inverse fast Fourier transform (IFFT).

In the reference signal generation unit 113, a reference signal (RS) for channel estimation is generated based on the information associated with the reference signal sequence input from the control signal detection unit 105, and is multiplexed on the data signal in the reference signal multiplexing unit 125. Although in the present example, the reference signal is multiplexed in the time domain, the reference signal may be multiplexed in the frequency domain. In a transmission processing unit 127, an end part of the time-domain signal multiplexed with the reference signal is copied as a cyclic prefix (CP) in a start position. The resultant time-domain signal is converted into an analog signal by a D/A conversion, and then is up-converted into a carrier frequency and transmitted from the antenna 101.

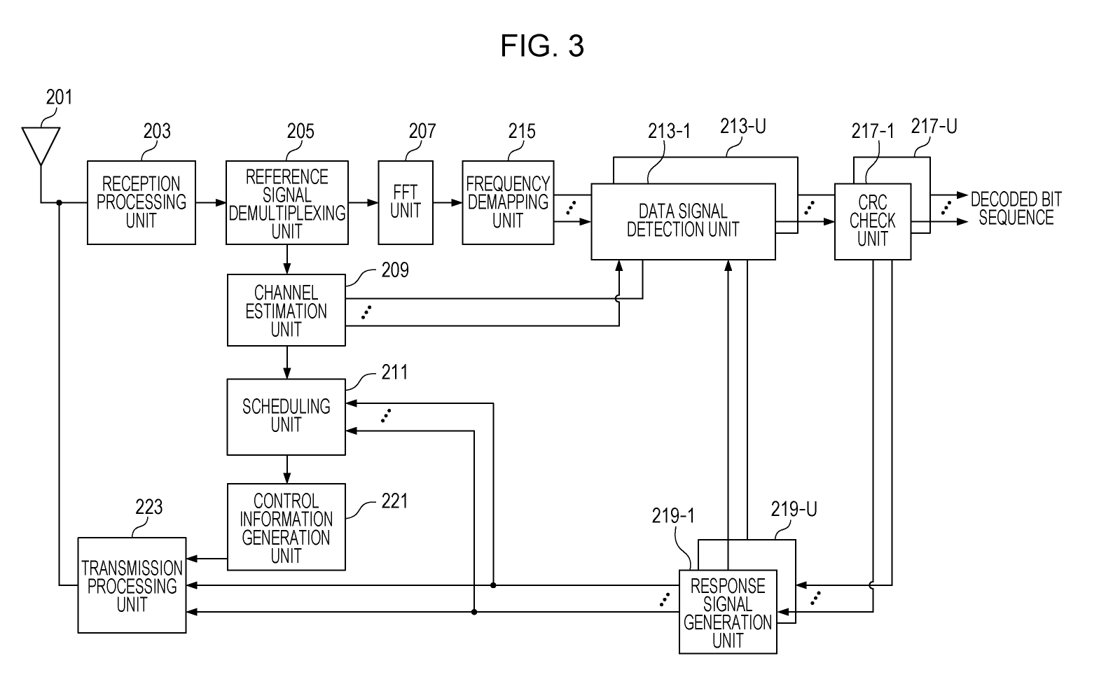

FIG. 3 is a block diagram illustrating a configuration of a base station apparatus according to the first embodiment of the present invention. Although one receive antenna is provided in this example, a plurality of receive antennas may be provided. In the following description, it is assumed that mobile station apparatuses of U stations are in connection with the base station apparatus. A received signal received by an antenna 201 is, in a reception processing unit 203, down-converted to a baseband signal and then converted into a digital signal by an A/D conversion. Thereafter, a CP is removed from the resultant digital signal. In a reference signal demultiplexing unit 205, a reference signal multiplexed on the received signal of each mobile station apparatus is demultiplexed, and the resultant reference signal is input to a channel estimation unit 209 and the remaining received signal is input to an FFT unit 207. In the channel estimation unit 209, a channel characteristic of each mobile station apparatus is estimated from the input reference signal and output to a scheduling unit 211 and data signal detection units 213-1 to 213-U.

On the other hand, in the FFT unit 207, the received signal remaining after being separated from the reference signal is subjected to a N_{FFT}-point fast Fourier transform (FFT) thereby being converted into a frequency-domain signal. The resultant frequency-domain signal is input to a frequency demapping unit 215. According to the assignment information determined when the scheduling unit 211 generates the control information, the frequency demapping unit 215 extracts frequency-domain signals in the N_{DFT}-point bands used by the respective mobile station apparatuses. The extracted frequency-domain signals are input to data signal detection units 213-1 to 213-U individually for the respective mobile station apparatuses, and a signal detection is performed using an iterative equalization technique.

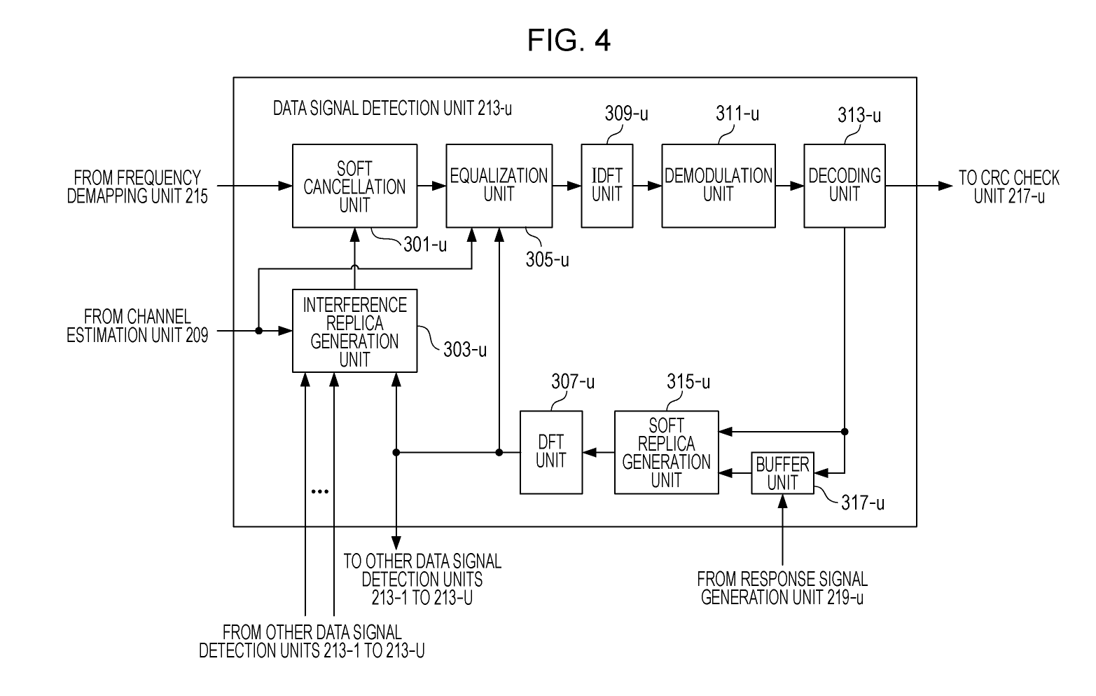

FIG. 4 is a block diagram illustrating an internal configuration of the data signal detection unit 213-u according to the first embodiment of the present invention. A soft cancellation unit 301-u subtracts a replica signal input from an interference replica generation unit 303-u from the frequency-domain signal input from the frequency demapping unit 215 thereby cancelling inter-symbol interference (ISI) occurring due to a delayed wave in a radio channel and also cancelling IUI that occurs when the same frequency is used by another mobile station apparatus in retransmission. However in a first-time process of a repetition in a case where there is no mobile station apparatus that performs a retransmission in the same cell, information associated with ISI and IUI is unknown, and thus nothing is cancelled out. A description will be given later for a case where there is a mobile station apparatus that performs a retransmission.

An equalization unit 305-u performs a multiplication of a minimum mean square error (MMSE) weight, a zero focusing (ZF) weight, or the like using an estimated channel value input from the channel estimation unit 209 thereby suppressing a residual interference component associated with the ISI and IUI, and a desired signal is combined using a soft replica input from a DFT unit 307-u. An IDFT unit 309-u converts a frequency-domain signal given as an output from the equalization unit 305-u into a time-domain signal via a N_{DFT}-point inverse Fourier transform (IDFT)). A demodulator 311-u calculates a log likelihood ratio (LLR) indicating reliability of each coded bit by performing a demodulation process according to a modulation scheme used in the transmission. Herein the log likelihood ratio is expressed by the natural logarithm (the logarithm to the base e, where e is a Napier's constant) of the ratio of a probability that the coded bit is 1 to a probability that coded bit is 0.

A decoding unit 313-u performs an error correction process on the LLR of each coded bit based on a maximum a posteriori (MAP) probability estimation, and outputs an extrinsic LLR of the coded bit with an improved likelihood to a soft replica generation unit 315-u and outputs a decoded bit obtained by performing a hard decision on a posterior LLR of an information bit to a CRC check unit (check unit) 217-u. However, in a case where the iterative process is ended, the extrinsic LLR of the coded bit is input to a buffer unit 317-u. Herein, the extrinsic LLR is a value obtained by subtracting the LLR of the coded bit input to the decoding unit 313-u from the posterior LLR of the coded bit with a likelihood improved via the error correction process, and the extrinsic LLR represents the reliability improved only via the error correction process. The information bits represent bits of each mobile station apparatus in a state in which the coding has not yet been performed.

The buffer unit 317-u has a function of storing the extrinsic LLR input from the decoding unit 313-u when the iterative equalization process is ended such that the extrinsic LLR is retained until a retransmission signal is received. However, in a case where the response signal input from the response signal generation unit 219-u is ACK, retransmission is not performed and thus the extrinsic LLR is not stored. In a case where the response signal is NACK, the extrinsic LLR stored when the retransmission signal corresponding to this response signal is received is input to the soft replica generation unit 315-u. In the soft replica generation unit 315-u, the expected value of the amplitude of each modulation symbol called a soft replica is calculated from the extrinsic LLR of the input code bit and then, in the DFT unit 307-u, is converted, by a N_{DFT}-point DFT, into a replica signal in the frequency domain. The replica signal output from the DFT unit 307-u is used by the equalization unit 305-u to combine a desired signal and is also input to the interference replica generation unit 303-u of each mobile station apparatus. Note that although not illustrated in FIG. 3, the output of the DFT unit 307-u is input to all data signal detection units 213-1 to 213-U corresponding to the respective mobile stations.

The interference replica generation unit 303-u first multiplies the replica signals input from the data signal detection units 213-1 to 213-U corresponding to the respective mobile stations by the estimated channel values of the respective mobile stations input from the channel estimation unit 209, and then calculates the total sum thereof over all mobile stations thereby generating the replica signal of the received signal. Furthermore, based on the assignment information determined by the scheduling unit 211, the interference replica generation unit 303-u extracts only the replica signal in a band used by a signal from which data is to be detected, and inputs the extracted replica signal to the soft cancellation unit 301-u.

An iteration of a sequence of processes described above in the data signal detection units 213-1 to 213-U is generally called a turbo equalization technique. After this iteration is performed an arbitrary number of times, decoded bits output from the decoding unit 313-u are output to the CRC check units 217-1 to 217-U. Alternatively, each time an iteration is performed, decoded bits may be output to the CRC check units 217-1 to 217-U, and, in a case where it is determined that there is no error, the iterative process may be ended.

The process described above is for a case where the received signal does not include a retransmission signal. In a case where a retransmission signal is transmitted from one of U mobile stations, a cancellation process is performed on the retransmission signal in a first-time iteration of the iterative process. In the data signal detection units 213-1 to 213-U corresponding to mobile stations that transmitted retransmission signals, first, the extrinsic LLR stored in the buffer unit 317-u is input to the soft replica generation unit 315-u, and a replica signal of the retransmission signal is generated. The generated replica signal is converted into a frequency-domain signal via the DFT unit 307-u and input to the interference replica generation unit 303-u of the data signal detection units 213-1 to 213-U of all mobile stations. Each of the interference replica generation units 303-1 to 303-U corresponding to the respective mobile stations generates an interference component from all input replica signals of retransmission signals and inputs the generated interference component to the soft cancellation unit 301-u. Thus, in the first-time iteration, the soft cancellation unit 301-u performs a subtraction of the interference component input from the interference replica generation unit 303-u, which makes it possible to reduce IUI. However, in the following iterations after the first-time iteration, the process is performed in a similar manner to a case where no retransmission signal exists.

In the CRC check units 217-1 to 217-U in FIG. 3, decoded bits are input from the respective data signal detection units 213-1 to 213-U, a determination is performed as to whether the decoded bits are correct by comparing CRC codes generated from the decoded bits with the CRC codes added to the bit sequences in the mobile station apparatuses. Only in a case where the decoded bits are correct, the decoded bit sequences are output as transmission data transmitted from the mobile station apparatuses. Results of determinations (as to whether decoding is correct or not) are input to the respective response signal generation units 219-1 to 219-U. Each of the response signal generation units 219-1 to 219-U generates an ACK signal when the input indicates that decoding is correct and a NACK signal when the input indicates that decoding is incorrect. Generated ACK signals or NACK signals are input to the transmission processing unit 223 and buffer units 317-1 to 317-U of the data signal detection units 213-1 to 213-U.

On the other hand, the estimated channel value of each mobile station apparatus estimated by the channel estimation unit 209 is input to the scheduling unit 211, which performs the frequency assignment and determines the modulation scheme and the coding rate to be used, and outputs the determined frequency assignment, the modulation scheme, and the coding rate to the control information generation unit 221. A method of determining the frequency assignment will be described later. In the control information generation unit 221, control information is generated from the output of the scheduling unit 211 and output to the transmission processing unit 223. Note that the control information may include additional information necessary for mobile station apparatuses to transmit signals (for example, information associated with reference signal sequences in a case where it is allowed to configure the reference signal sequences individually for respective mobile station apparatuses). In the transmission processing unit 223, control information or the response signal is subjected to a D/A conversion and an up-conversion to a radio frequency at a predetermined timing and then transmitted to each mobile station apparatus from the antenna 201. Note that the control information and the response signal are also necessary in the data reception process, and thus the control information and the response signal are stored based on the notified information until transmitted data is received.

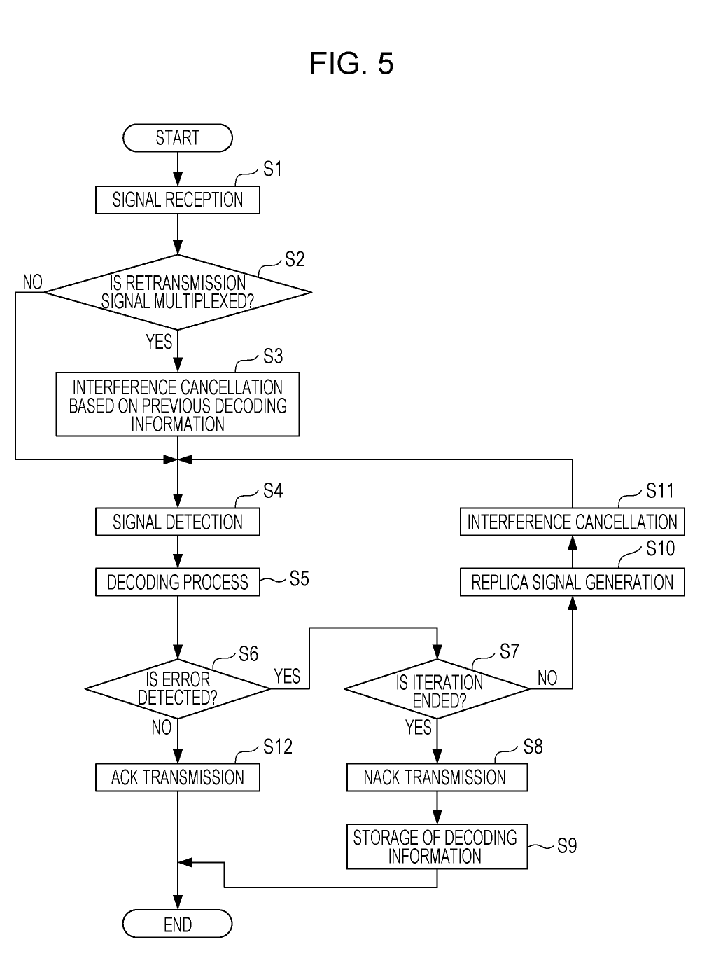

FIG. 5 is a flow chart illustrating an operation of a base station apparatus according to the first embodiment of the present invention. The base station apparatus receives a signal on which initial transmission signals or retransmission signals are multiplexed (step S1). Next, the base station apparatus determines whether the received signal includes a retransmission signal (step S2). In a case where no retransmission signal is included (step S2: No), step 3 is skipped. In a case where a retransmission signal is included (step S2: Yes), soft replicas are generated from extrinsic LLRs in a previous transmission opportunity stored in the buffer units 317-1 to 317-U, and then, in the soft cancellation unit 301-u corresponding to each mobile station apparatus, IUI and ISI is cancelled out (step S3).

Subsequently, the base station apparatus performs the equalization process and the demodulation process based on the estimated channel value to detect a signal (step S4). Next, the base station apparatus performs the error correction decoding process (step S5). The base station apparatus determines whether the signal includes an error (step S6). In a case where an error is detected (step S6: Yes), the base station apparatus determines whether the iterative process is to be performed (step S7). In a case where the iterative process is to be ended (step S7: Yes), the base station apparatus transmits NACK to the mobile station apparatus (step S8), and stores the LLR of the coded bit obtained in step S5 for use in interference cancellation in first-time processing in retransmission (step S9). In a case where it is determined in step S7 that the iterative process is to be performed (step S7: No), the base station apparatus generates a replica signal from the LLR obtained in step S5 (step S10). The base station apparatus performs the interference cancellation using the replica signal generated in step S10 (step S11), and then returns to step S4. Thereafter, the iterative process is performed until no error is detected in step S6 or it is determined in step S7 that the iterative process is to be ended. In a case where no error is detected in step S6, then, in step S12, the base station apparatus transmits ACK to the mobile station apparatus and ends the process.

In the present embodiment, a band assigned to a mobile station that performs a retransmission is allowed to be overlapped with a band assigned to a mobile station that performs an initial transmission. As a result, it becomes possible to prevent a reduction in overall throughput of a cell as a whole due to a retransmission. Note that in the overlapping band, soft cancellation is performed using decoding information stored when the previous transmission was performed by the mobile station that performs the retransmission thereby suppressing degradation due to IUI.

### Second Embodiment

In the first embodiment described above, a band assigned to a mobile station that performs a retransmission is overlapped with a band assigned to a mobile station that performs an initial transmission, and signals are separated using decoding information stored when the previous transmission was performed by the mobile station that performs the retransmission. However, in a case where the stored decoding information includes an error and the reliability of the decoding information is low, there is a possibility that the reduction in IUI by the soft cancellation is small. In view of the above, the present embodiment discloses a technique of determining whether overlapping is allowed for a mobile station that performs an initial transmission or determining an overlapping amount depending on the magnitude of an LLR of a code bit given after an iterative process is performed for a mobile station that performs a retransmission. In the present embodiment, the basic configuration of a mobile station apparatus is similar to that of the first embodiment illustrated in FIG. 2, and thus a further description thereof is omitted.

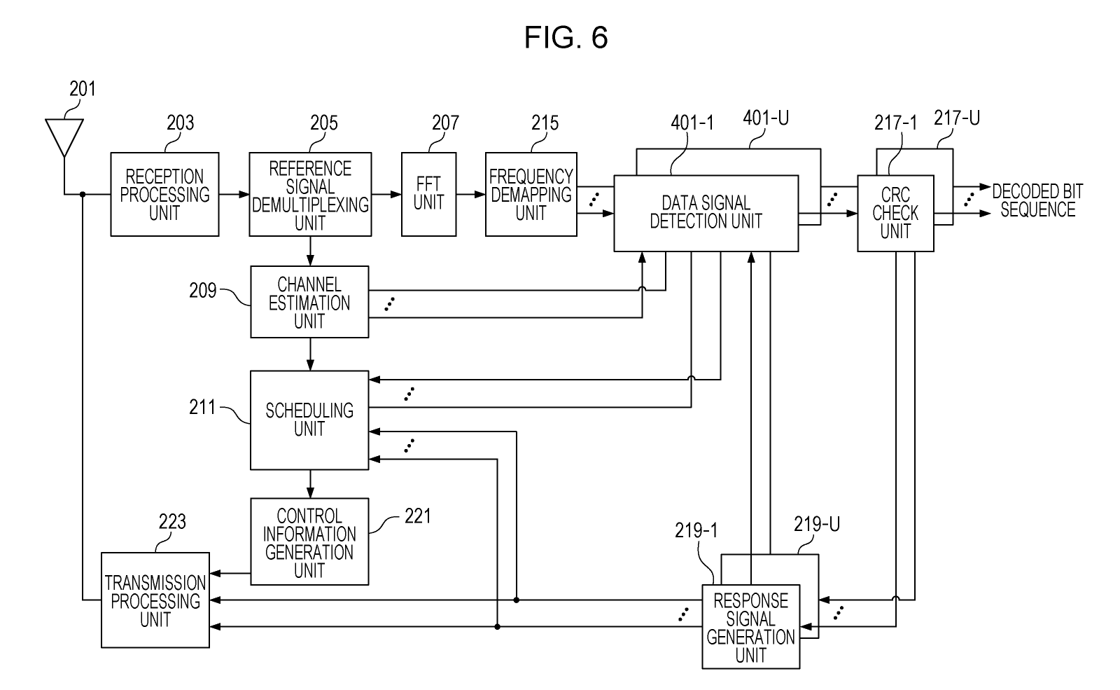

FIG. 6 is a block diagram illustrating an example of a basic configuration of a mobile station apparatus according to a second embodiment of the present invention. Blocks having similar functions to those of the first embodiment illustrated in FIG. 3 are denoted by similar reference symbols, and a further description thereof is omitted. On the other hand, the data signal detection units 213-1 to 213-U in FIG. 3 are replaced by data signal detection units 401-1 to 401-U in FIG. 6 having a function of determining whether or not a band assigned to a mobile station apparatus that is to perform a retransmission in next transmission opportunity is to be allowed to be overlapped with a band assigned to another mobile station apparatus that is to perform an initial transmission.

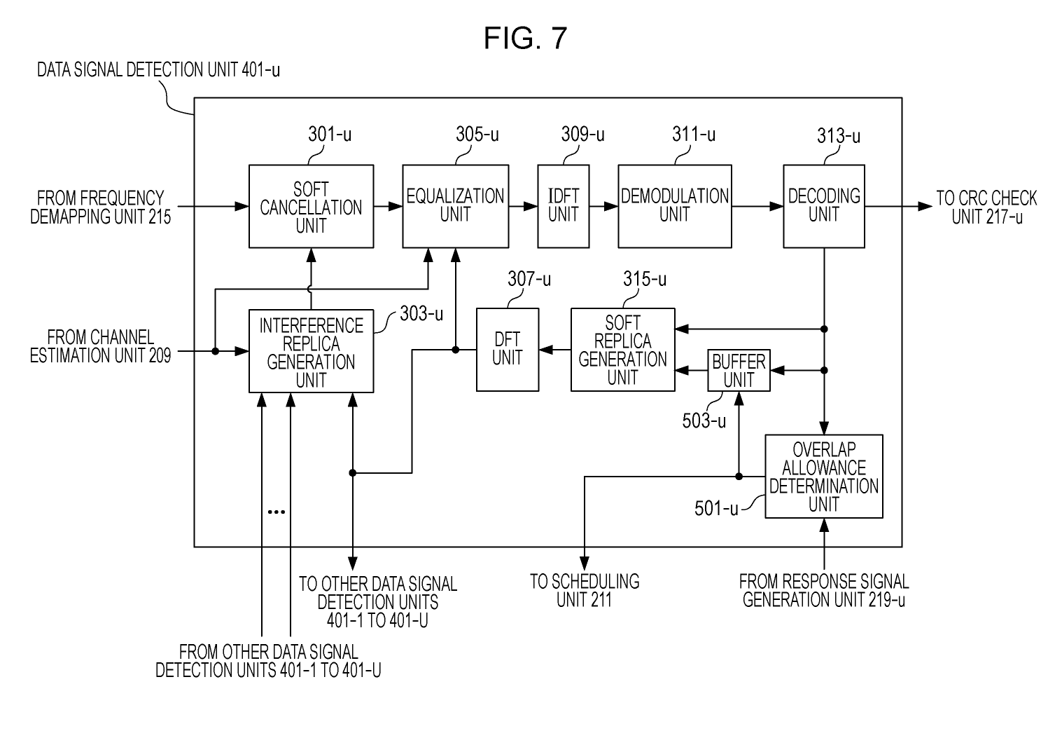

FIG. 7 is a block diagram illustrating an example of an internal configuration of data signal detection units 401-1 to 401-U according to the second embodiment of the present invention. The data signal detection units 401-1 to 401-U illustrated in FIG. 7 are different from the data signal detection units 213-1 to 213-U illustrated in FIG. 4 in that an overlap allowance determination unit 501-u is provided and in that the buffer units 503-1 to 503-U are different in function. However, the other blocks have similar functions and thus a further description thereof is omitted.

In a case where a response signal to a uth mobile station apparatus, input from a response signal generation unit 219-u, is NACK, an overlap allowance determination unit 501-u makes a determination based on an LLR of a coded bit output from a decoding unit 313-u as to whether a band assigned to the uth mobile station apparatus is to be allowed to be overlapped with a band assigned to another mobile station apparatus. This determination as to whether to allow the overlapping is performed depending on whether the mean value of absolute values of LLRs of coded bits is equal to or greater than a criterion value. That is, the overlap allowance determination unit 501-u has a criterion value LC. When an LLR of a kth code bit of the uth mobile station apparatus input from the decoding unit 313-u is Lᵤ(k)εC^{Nsym×1} (where Nsym is the number of code bits), the mean value L_{u,ave} of the LLRs is calculated according to the following equation.

$$[ Math . 1 ] \begin{matrix} & \\ {L}_{u , ave} = \frac{1}{{N}_{sym}} {\sum }_{k = 1}^{{N}_{sym}} \vert {L}_{u} ( k ) \vert & ( 1 )\end{matrix}$$

In a case where “L_{u,ave}≧LC”, it is determined that the assigned band for the uth mobile station is allowed to be overlapped with an assigned band for another mobile station. In a case where “L_{u,ave}<LC”, it is determined that overlapping is not allowed. Note that a determination result is output to the buffer unit 503-u and a scheduling unit 211 in FIG. 6.

In a case where the determination result input from the overlap allowance determination unit 501-u indicates that overlapping is allowed, an extrinsic LLR of a code bit output at this point of time from the decoding unit 313 is stored in a buffer unit 503-u. When a retransmitted signal is received, the stored extrinsic LLR is output to a soft replica generation unit 315-u. In the other cases, the extrinsic LLR input from the decoding unit 313 is directly output to the soft replica generation unit 315-u.

An estimated channel value of each mobile station is input from a channel estimation unit 209 to a scheduling unit 211 in FIG. 6. Furthermore, from the data signal detection units 401-1 to 401-U, a determination result is input as to whether an assigned band for each mobile station is allowed to be overlapped with an assigned band for another mobile station. Furthermore, from response signal generation units 219-1 to 219-U, response signals of respective mobile stations are input. Based on these pieces of information, the scheduling unit 211 in FIG. 6 performs determinations as to the frequency assignment, a modulation scheme to be used, and a coding rate.

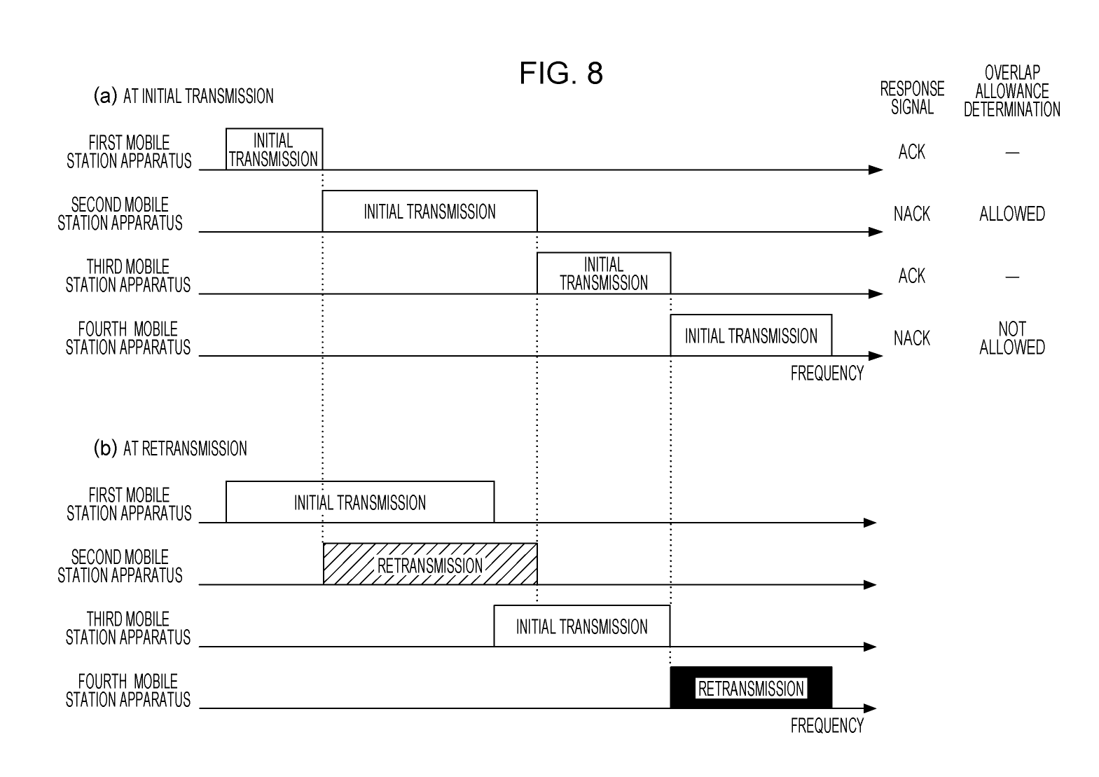

FIG. 8 is a diagram illustrating a method of assigning bands to mobile station apparatuses by the scheduling unit 211 according to the second embodiment of the present invention. In this example, a first mobile station apparatus, a second mobile station apparatus, a third mobile station apparatus and a fourth mobile station apparatus map a first transmission signal, a second transmission signal, a third transmission signal and a fourth transmission signal such that they are orthogonal on a frequency axis, and perform initial transmissions. When these transmission signals are received by a base station apparatus, if no signal detection error occurs in the first mobile station apparatus and the third mobile station apparatus, but signal detection errors occur in the second mobile station apparatus and the fourth mobile station apparatus, then the base station apparatus transmits, as response signals, ACK to the first mobile station apparatus and the third mobile station apparatus and NACK to the second mobile station apparatus and the fourth mobile station apparatus.

Then in a case where results of overlapping allowance determinations performed by the data signal detection units 401-1 to 401-U indicate that LLRs of the second mobile station apparatus are high enough to allow overlapping but LLRs of the fourth mobile station apparatus are small and overlapping is not allowed for the fourth mobile station apparatus, the scheduling unit 211 assigns transmission bands to the respective mobile station apparatuses as illustrated in FIG. 8(b). First, the same bands as the bands used in the initial transmissions are assigned to the second mobile station apparatus and the fourth mobile station apparatus that are to perform retransmissions, and then all bands excluding the band assigned to the fourth mobile station apparatus, which is not allowed to be overlapped, are assigned to the first mobile station apparatus and the third mobile station apparatus. However, in a case where when a retransmission is performed, a new fifth mobile station apparatus performs an initial transmission, bands may be assigned such that overlapping with the second mobile station apparatus is allowed and further more bands used by the first mobile station apparatus, the third mobile station apparatus, and the fifth mobile station apparatus are different from each other. By performing the assignment in the above-described manner, it is possible to prohibit overlapping for a mobile station apparatus that is difficult to cancel IUI by decoding information in an initial transmission and it is further possible to more increase a band assignable to a mobile station apparatus that performs an initial transmission than is possible by the conventional retransmission control.

Although in the present embodiment described above, the determination as to whether overlapping is allowed or not is made based on a result of a comparison of the mean value of LLRs of coded bits output from the decoding unit 313 with respect to only one criterion value, a plurality of criterion values may be prepared and the amount of overlapping may be limited depending on a comparison result. For example, two criterion values L_{c1}<L_{c2} are prepared and L_{u,ave} are compared with these two criterion values. In a case where L_{u,ave}<L_{c1}, overlapping is not allowed for a retransmission signal from a uth mobile station. In a case where L_{c1}≦L_{u,ave}<L_{c2}, overlapping of up to 50% of a band assigned to the retransmission signal of the uth mobile station is allowed. In a case where L_{u,ave}≧L_{c2}, the uth mobile station is allowed to be overlapped with another initial transmission signal. By limiting the amount of overlapping depending on the magnitude of the LLR of the coded bit of the initial transmission signal, that is, the reliability thereof in the above-described manner, it becomes possible to limit IUI that occurs, which makes it easy to separate signals among mobile stations by the turbo equalization process.

Although in the present embodiment described above, the determination is performed based on the mean values of absolute values of LLRs of coded bits output from the decoding unit 313, other different criterions may be used as long as the criterions indicate the reliability of the decoding information.

### Third Embodiment

In the first embodiment and the second embodiment described above, on the assumption that when a retransmission is performed, the same signal as the signal transmitted in an initial transmission is transmitted, signals are overlapped between a retransmission signal from a mobile station apparatus that performs a retransmission and an initial transmission signal from a mobile station apparatus that performs an initial transmission. In a third embodiment disclosed below, an IR method, which is one of H-ARQ methods, is used as a retransmission scheme in which a retransmission signal and an initial transmission signal are overlapped, and signals are combined using the IR method after IUI is cancelled by performing a nonlinear iterative process.

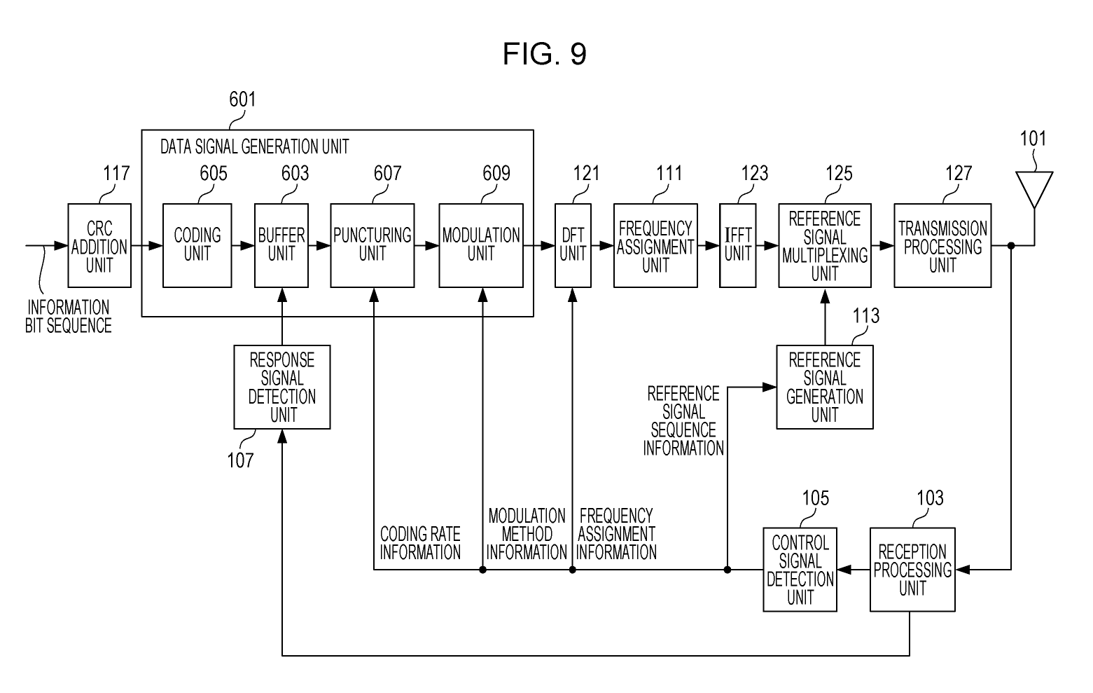

FIG. 9 is a block diagram illustrating an example of a basic configuration of a mobile station apparatus according to a third embodiment of the present invention. The mobile station apparatus in FIG. 9 is different from the mobile station apparatus in FIG. 2 in a configuration of a data signal generation unit 601 and functions of a buffer unit 603. The other blocks denoted by similar reference symbols have similar functions to those of the mobile station apparatus in FIG. 2, and thus a further description thereof is omitted.

The data signal generation unit 601 includes a coding unit 605, a buffer unit 603, a puncturing unit 607, and a modulation unit 609. In general, an error correction code gives a restriction and a redundancy to information bits. Details of a manner of giving the restriction and the redundancy depend on a configuration of an encoder. For example, in the case of the turbo code, when an information bit length is N bits, 2N bits are added as parity bits, and thus 3N bits are output as code bits. This means that the turbo encoder performs encoding with a coding rate of 1/3, which is defined as base coding. Furthermore, in a case where the coding rate is changed depending on reception quality such as a reception SINR, an arbitrary coding rate is achieved by deleting part of code bits coded with the base coding rate according to a deletion rule (puncture pattern). In the case of a convolutional code, an encoder is allowed to be configured for various base coding. In the case of a coding rate of 1/2, which is widely employed, resultant code bits have a length of 2N, and an arbitrary coding rate (3/4, 7/8, and so on) is achieved by deleting bits from the code bits based on a puncture pattern.

In the puncturing unit 607, coding rate information R is input from the control signal detection unit 105, and a process (puncturing process) is performed to delete part of coded bits based on a deletion rule (puncture pattern) varying depending on the number of transmissions. Coded bits generated by the puncturing have a length of N/R bits and are output to the modulation unit 609.

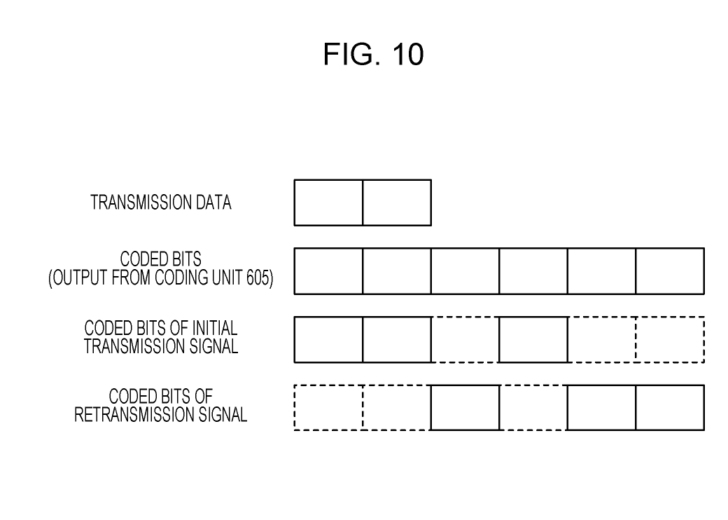

FIG. 10 is a diagram illustrating an example of a manner in which coded bits are generated by the coding unit 605 and the puncturing unit 607. In FIG. 10, the base coding rate of the coding unit 605 is 1/3, and control information is input to the puncturing unit 607 to indicate that the coding rate R of information bits to be transmitted is 2/3. Furthermore, in this example, it is assumed that in the puncturing unit 607, “P1=1, 1, 0, 1, 0, 0” is used as a puncture pattern for initial transmissions, and “P2=0, 0, 1, 0, 1, 1” for retransmissions. When 2 bits of transmission data are input to the coding unit 605, coded bits with a length of 6 bits are generated by error correction coding. The generated coded bits are first stored in the buffer unit 603 and then punctured by the puncturing unit 607.

For the initial transmission, the puncture pattern P1 is used, and thus 3rd, 5th, and 6th bits of the 6-bit coded bits are deleted, and only 1st, 2nd, and 4th bits are output. In a case where NACK is received as a response signal to the initial transmission, the mobile station apparatus outputs the 6-bit coded bits stored in the buffer unit 603 to the puncturing unit 607. In the puncturing unit 607, puncturing is performed using the puncture pattern P2. The 1st, 2nd, and 4th bits of the coded bits are deleted, and the 3rd, 5th, and 6th bits are output. By performing deletion such that bits deleted in the retransmission signal are different from bits deleted in the initial transmission signal in the above-described manner, it becomes possible to perform complementing in the retransmission on the assumption that an error in the initial transmission signal is due to a deleted code bit that make no contribution to the error correction thereby achieving error correction decoding with a low coding rate. The modulation unit 609 performs a modulation process such as QPSK, 16QAM, 64QAM, or the like according to modulation scheme information input from the control signal detection unit 105.

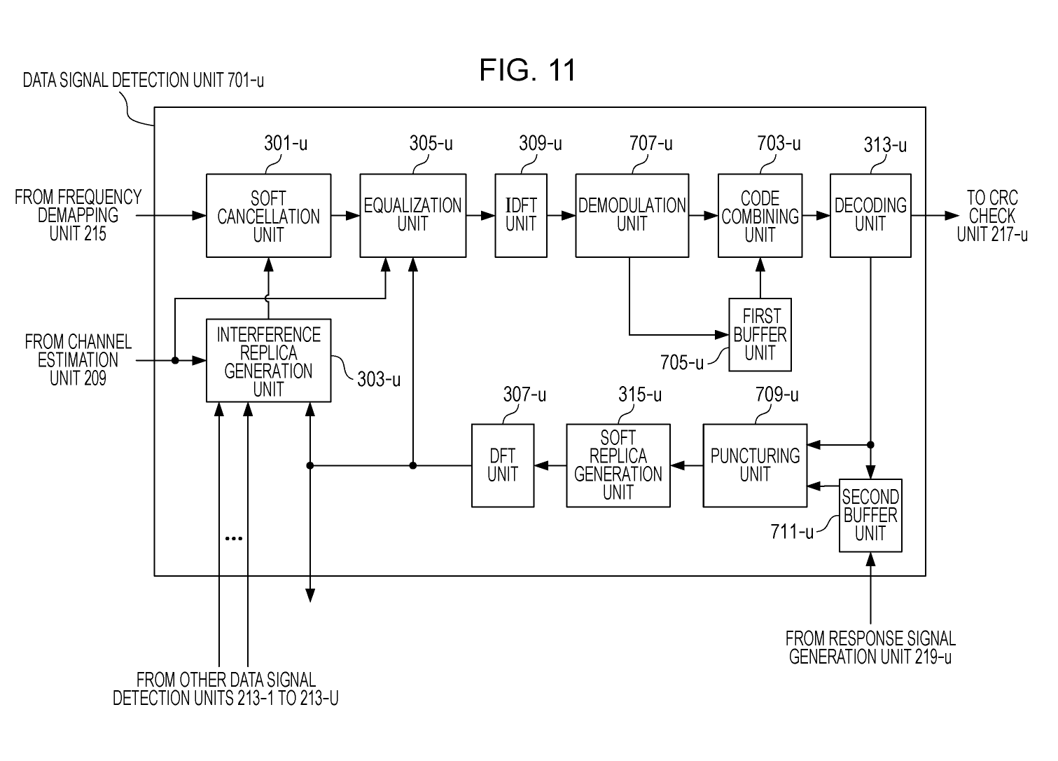

FIG. 11 is a block diagram illustrating a configuration of a base station apparatus according to the third embodiment of the present invention. The configuration of the base station apparatus according to the third embodiment is similar to the configuration of the base station apparatus according to the first embodiment illustrated in FIG. 3 except that the configuration of the data signal detection unit 701-u is partially different. The data signal detection unit 701-u in FIG. 11 includes a code combining unit 703-u. A first buffer unit 705-u stores an LLR of a coded bit obtained by the demodulator 707-u at the end of the iteration in the initial transmission and in each retransmission opportunity. The stored value of the LLR is output to the code combining unit 703-u in next and following retransmissions. In a case where a signal to be detected is a retransmission signal, the code combining unit 703-u combines the coded bits input from the demodulator 707-u with the coded bits stored in the first buffer unit 705-u. In the IR method, in each transmission opportunity, different bits of coded bits are punctured, and thus the combining makes it possible to achieve a coding gain higher than the coding rate used in the transmission.

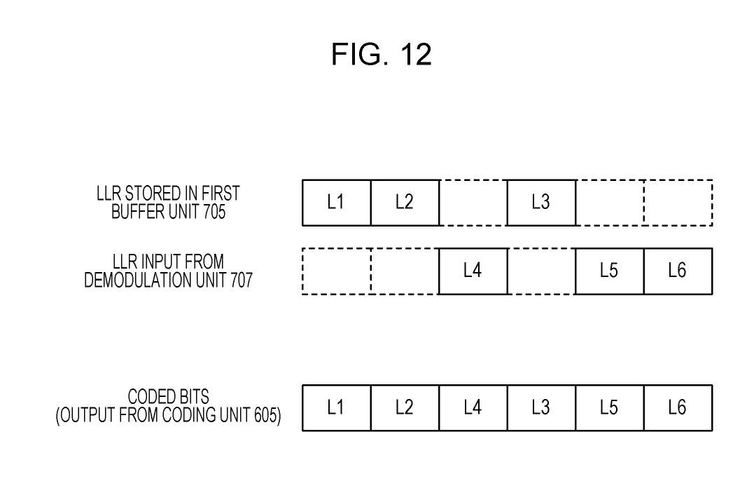

FIG. 12 is a diagram illustrating an example of a combining method for a case where an initial transmission signal and a retransmission signal illustrated in FIG. 10 are transmitted by a mobile station apparatus according to the third embodiment of the present invention. In a case where LLRs stored in the first buffer are L1, L2, and L3, these correspond to bits transmitted in an initial transmission signal and respectively represent the LLRs of the 1st, 2nd, and 4th bits of coded bits before being punctured. On the other hand, in a case where LLRs input from the demodulator 707-u in a retransmission are L4, L5, and L6, these correspond to bits transmitted in a retransmission signal and respectively represent likelihood of the 3rd, 5th, and 6th bits of coded bits before being punctured. Thus, the code combining unit 703-u combines these LLRs and outputs L1, L2, L4, L3, L5, and L6 as LLRs of the first to 6th coded bits to the decoding unit 313.

The decoding unit 313-u performs an error correction process on the LLRs of the respective coded bits and outputs resultant extrinsic LLRs of the coded bits with improved likelihoods to the puncturing unit 709-u and outputs posterior LLRs of the information bits to the CRC check unit 217-u. However, when the iterative process is ended, the extrinsic LLRs of the coded bits are output to the second buffer unit 711-u. In a case where NACK is received from the response signal generation unit 219-u, the second buffer unit 711-u stores the extrinsic LLRs input from the decoding unit 313-u until a next retransmission. The stored extrinsic LLRs are output to the puncturing unit 709-u before an iterative process is performed when a retransmission signal is received. The puncturing unit 709-u performs puncturing on the input extrinsic LLRs of the coded bits using a puncture pattern determined depending on the number of retransmissions, as in the mobile station apparatus. Note that the soft cancellation unit 301-u has a function similar to that illustrated in FIG. 4.

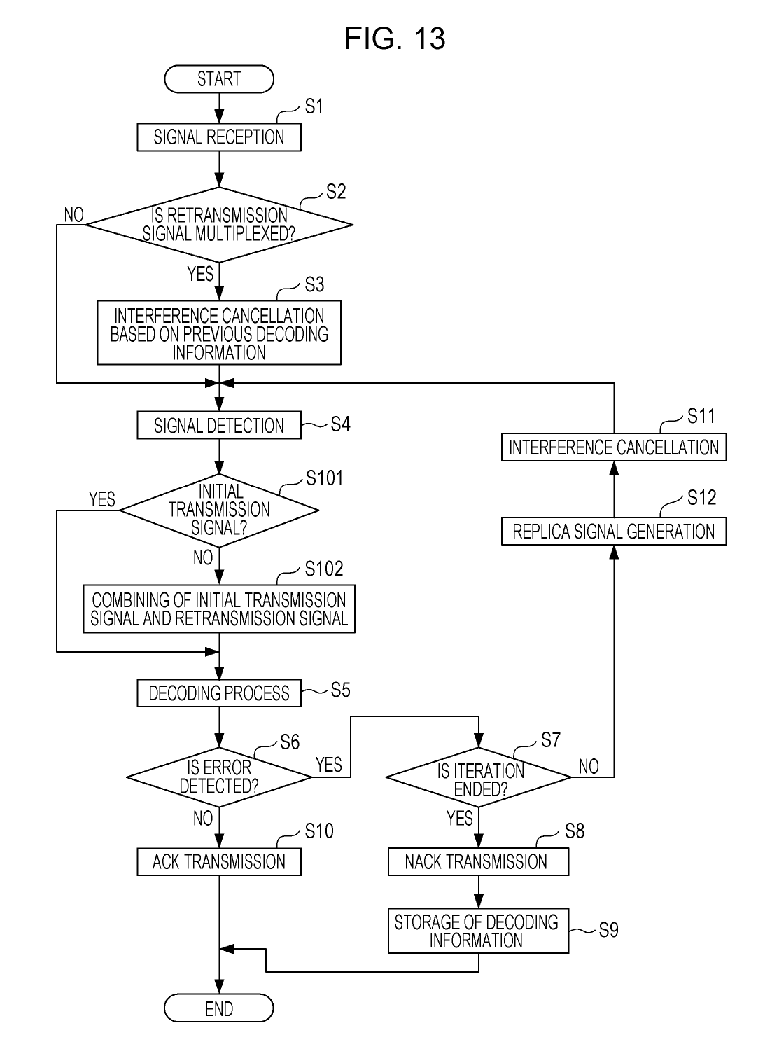

FIG. 13 is a flow chart illustrating an operation of the base station apparatus according to the third embodiment of the present invention. Steps denoted by the same reference symbols as those in the flow chart in FIG. 5 have the same functions. However, in the present embodiment, after the signal detection in step S4, the base station apparatus determines whether the detected signal is an initial transmission signal (step S101). In a case where it is an initial transmission signal, (step S101: Yes), step S102 is skipped. In a case where the detected signal is not an initial transmission signal (but the signal is a retransmission signal) (step S101: No), the base station apparatus combines the obtained LLRs of the coded bits with the LLRs of the coded bits stored in the transmission opportunity thereby generating LLRs of coded bits (step S102).

In the present embodiment described above, the IR method is used in which puncturing is performed differently between an initial transmission and a retransmission. Note that the embodiment is also applicable to the CC method. In a case where the CC method is used, puncturing is performed in the same manner for both initial transmission and retransmission, and the code combining unit 703-u of the base station apparatus performs maximum ratio combining of the LLR of the initial transmission signal and the LLR of the retransmission signal.

In the present embodiment, in the case where the IR method is used as the retransmission scheme, a band assigned to a mobile station that performs an initial transmission is allowed to be overlapped. This makes it possible for the coding gain to be improved by a retransmission, and thus it becomes possible to suppress the number of retransmissions while preventing a reduction in overall throughput of a cell as a whole due to retransmissions.

The present invention provides a program that operates on a mobile station apparatus and a base station apparatus. The program controls a CPU or the like (or controls a computer to operate) so as to realize the functions of the above-described embodiments according to the present invention. Information treated by these apparatuses is temporarily stored in a RAM during processing, and then is stored in various types of ROMs or an HDD. The information stored in the ROMs or the HDD is read by the CPU as required, and modified or rewritten. As for a storage medium for storing the program, any one of a semiconductor medium (for example, a ROM, a non-volatile memory card, and the like), an optical storage medium (for example, DVD, MO, MD, CD, BD, and the like), and a magnetic storage medium (for example, a magnetic tape, a flexible disk, and the like) may be used.

The functions of the embodiments described above can be realized not only by executing the loaded program, but the functions of the invention may also be realized by performing processing according to instructions of the program in cooperation with an operating system or other application programs or the like. To provide the program in markets, the program may be stored in a portable storage medium, or the program may be transferred to a server computer connected via a network such as the Internet. In this case, a storage apparatus of the server computer falls within the scope of the present invention.

Part or all of the mobile station apparatus and the base station apparatus according to the embodiments described above may be realized typically by an LSI which is an integrated circuit. Each functional block of the mobile station apparatus and the base station apparatus may be individually realized in the form of a chip, or part or all thereof may be integrated on a chip. The realization of the integrated circuit is not limited to the LSI but may be realized as a dedicated circuit or a general-purpose processor. When an advance in semiconductor technology provides an integrated circuit technique which replace LSIs, such an integrated circuit technique will be usable.

Although the embodiments of the present invention have been described in detail above with reference to the drawings, details are not limited to those of the embodiments, but designs are possible without departing from the spirit and scope of the present invention.

### REFERENCE SIGNS LIST

101 antenna
103 reception processing unit
105 control signal detection unit
107 response signal detection unit
109 data signal generation unit
111 frequency assignment unit
113 reference signal generation unit
115 initial transmission/retransmission switch unit
117 CRC addition unit
119 buffer unit
121 DFT unit
123 IFFT unit
125 reference signal multiplexing unit
127 transmission processing unit
201 antenna
203 reception processing unit
205 reference signal demultiplexing unit
207 FFT unit
209 channel estimation unit
211 scheduling unit
213-1 to 213-U, 213 data signal detection unit
215 frequency demapping unit
217-1 to 217-U, 217 CRC check unit
219-1 to 219-U, 219 response signal generation unit
221 control information generation unit
223 transmission processing unit
301-1 to 301-U, 301 soft cancellation unit
303-1 to 303-U, 303 interference replica generation unit
305-1 to 305-U, 305 equalization unit
307-1 to 307-U, 307 DFT unit
309-1 to 309-U, 309 IDFT unit
311-1 to 311-U, 311 demodulator
313-1 to 313-U, 313 decoding unit
315-1 to 315-U, 315 soft replica generation unit
317-1 to 317-U, 317 buffer unit
401-1 to 401-U, 401 data signal detection unit
501-1 to 501-U, 501 overlap allowance determination unit
503-1 to 503-U, 503 buffer unit
601 data signal generation unit
603 buffer unit
605 coding unit
607 puncturing unit
609 modulation unit
701-1 to 701-U, 701 data signal detection unit
703-1 to 703-U, 703 code combining unit
705-1 to 705-U, 705 first buffer unit
707-1 to 707-U, 707 demodulator
709-1 to 709-U, 709 puncturing unit
711-1 to 711-U, 711 second buffer unit

1. A receiving apparatus that includes at least one receive antenna and, in a case where a signal received from a transmitting apparatus includes an error, requests the transmitting apparatus to provide a retransmission signal, comprising:
a check unit that makes a determination as to whether the signal received from the transmitting apparatus includes an error; and
a scheduling unit that, in a case where a result of the determination indicates that the received signal includes an error, performs a frequency assignment such that a frequency band for use by the transmission apparatus to transmit the retransmission signal are overlapped by the same number of other signals as the number of receive antennas or more.

2. The receiving apparatus according to claim 1, wherein the scheduling unit performs the frequency assignment such that at least a part of the frequency band used by the transmitting apparatus to transmit the retransmission signal overlaps at least a part of a frequency band used by the transmitting apparatus or another different transmitting apparatus to transmit a signal other than the retransmission signal.

3. The receiving apparatus according to claim 1, wherein the scheduling unit performs the frequency assignment such that at least a part of the frequency band used by the transmitting apparatus to transmit the retransmission signal overlaps at least a part of a frequency band used by the other transmitting apparatus to transmit an initial transmission signal.

4. The receiving apparatus according to claim 1, wherein in a case where the received signal includes an error, the scheduling unit performs a determination based on decoding information as to whether or not to perform the frequency assignment such that at least a part of the frequency band used by the transmitting apparatus to transmit the retransmission signal overlaps at least a part of a frequency band used by the other transmitting apparatus to transmit an initial transmission signal.

5. The receiving apparatus according to claim 4, wherein
the decoding information is a mean absolute value of log likelihood ratios of coded bits obtained after a decoding process is performed, and
the scheduling unit performs the frequency assignment such that in a case where the decoding information is equal to or greater than a predetermined reference value, at least a part of the frequency band used by the transmitting apparatus to transmit the retransmission signal overlaps at least a part of a frequency band used by the other transmitting apparatus to transmit an initial transmission signal, while in a case where the decoding information is smaller than the predetermined reference value, the frequency band used by the transmitting apparatus to transmit the retransmission signal does not overlap the frequency band used by the other transmitting apparatus to transmit the initial transmission signal.

6. The receiving apparatus according to claim 4, wherein the scheduling unit determines an overlapping ratio between the frequency band used by the transmitting apparatus to transmit the retransmission signal and the frequency band used by the other transmitting apparatus to transmit the initial transmission signal.

7. The receiving apparatus according to claim 1, farther comprising a code combining unit that combines the signal including the error and the retransmission signal by using Chase combining (CC).

8. The receiving apparatus according to claim 1, further comprising a code combining unit that combines the signal including the error and the retransmission signal by using incremental redundancy (IR).

9. The receiving apparatus according to claim 1, comprising:
a buffer unit that stores decoding information in a case where the received signal includes an error;
a soft replica generation unit that, in a case where the retransmission signal is received from the transmitting apparatus, generates a replica of the retransmission signal based on the decoding information stored in the buffer unit;
an interference replica generation unit that generates an interference replica by using the replica of the retransmission signal and information indicating an interference received by another transmitting apparatus; and
a soft cancellation unit that cancels an inter-user interference from the received retransmission signal by using the interference replica.

10. A method of assigning a frequency to a receiving apparatus that requests a transmitting apparatus to provide a retransmission signal in a case where a signal received from the transmitting apparatus includes an error, comprising:
in the case where the received signal includes an error, performing a frequency assignment such that a frequency band for use by the transmitting apparatus to transmit the retransmission signal is overlapped by the same number of other signals as the number of receive antennas or more.

11. (canceled)

12. An integrated circuit that is disposed in a receiving apparatus to allow the receiving apparatus to have a plurality of functions comprising:
a function of, in a case where a signal received from a transmitting apparatus includes an error, requesting the transmitting apparatus to provide a retransmission signal;
a function of determining whether the signal received from the transmitting apparatus includes an error or not; and
a function of, in a case where a result of the determination indicates that the received signal includes an error, performing a frequency assignment such that a frequency band for use by the transmitting apparatus to transmit the retransmission signal is overlapped by the same number of other signals as the number of receive antennas or more.
